(19) United States
(12) Patent Application Publication
(10) Pub. No.: US 2013/0024057 A1
(43) Pub. Date: Jan. 24, 2013

(54) VEHICLE TRAVEL TORQUE CONTROL SYSTEM AND CONTROL METHOD THEREOF

(71) Applicants: Minyoung JUNG, Hwaseong-si (KR); Junyong Lee, Hwaseong-si (KR); Daekwang Kim, Hwaseong-si (KR); Chikung Ahn, Hwaseong-si (KR)

(72) Inventors: Minyoung JUNG, Hwaseong-si (KR); Junyong Lee, Hwaseong-si (KR); Daekwang Kim, Hwaseong-si (KR); Chikung Ahn, Hwaseong-si (KR)

(73) Assignee: HYUNDAI MOTOR COMPANY, Seoul (KR)

(21) Appl. No.: 13/298,138

(22) Filed: Nov. 16, 2011

(30) Foreign Application Priority Data
Jul. 21, 2011 (KR) KR10-2011-0072342

(51) Int. Cl. B60W 20/00

(52) U.S. Cl. 701/22; 180/65.265; 903/930

(57) ABSTRACT

A vehicle travel torque control system may include a sensing module that interworks with an engine control unit (ECU) controlling an engine, a transmission control unit (TCU) controlling a transmission, and a motor control unit (MCU) controlling a motor/an alternator, to collect information associated with each of the units, a motor torque compensating calculation module that determines a variation value of a vehicle speed by comparing an actual vehicle speed of a vehicle with a target vehicle speed determined based on the information collected by the sensing module to determine a torque deviation value of a travel torque and determines a torque correction value by using the determined torque deviation value of the travel torque, and an ECU motor torque outputting module that corrects a target torque amount of the engine by using the torque correction value and outputs a corrected target torque amount to the ECU.

### CROSS-REFERENCE TO RELATED APPLICATIONS

The present application claims priority to Korean Patent Application Number 10-2011-0072342 filed Jul. 21, 2011, the entire contents of which application is incorporated herein for all purposes by this reference.

### BACKGROUND OF THE INVENTION

1. Field of the Invention

The present invention relates to a vehicle travel torque control system, and more particularly, to a travel torque control system for a vehicle travelled by an engine and a motor of the vehicle.

2. Description of Related Art

In recent years, a vehicle travel torque control system applied to an electronic control engine of a vehicle calculates a required torque amount required for travelling by determining drive's intention and automatically controls torque of an engine by adjusting control variables such as a fuel amount, an ignition time, and an air amount based the calculated torque amount when a driver steps an acceleration pedal.

However, when a motor is used except in addition to the engine like a hybrid vehicle, a torque generating source is added, and as a result, it is difficult to apply the vehicle travel torque control system applied to the electronic control engine in the related art as it is. In particular, the development of a technology capable of controlling the engine by considering even torque variation by component deviations of the motor is insufficient.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to provide a vehicle travel torque control system capable of controlling torque of an engine by considering a torque deviation of a motor.

In an aspect, the present invention provides a vehicle travel torque control system controlling torque of an engine, including a sensing module that interworks with an engine control unit (ECU) controlling an engine, a transmission control unit (TCU) controlling a transmission, and a motor control unit (MCU) controlling a motor/an alternator to collect information associated with the engine, the transmission, and the motor/alternator, a motor torque compensating calculation module that compares an actual vehicle speed of a vehicle with a target vehicle speed calculated based on the collected information collected by the sensing module to calculate a deviation of travel torque and calculates a torque correction value by using the calculated deviation of the travel torque, and an ECU motor torque outputting module that corrects a target torque amount of the engine by using the torque correction value and outputs the corrected target torque amount to the ECU.

In another aspect, the present invention provides a control method of a vehicle travel torque control system that interworks with an engine control unit (ECU), a transmission control unit (TCU), and a motor control unit (MCU) controlling a motor/an alternator, the method including determining whether a value of a cooling water temperature transmitted from the ECU is larger than a set value for a predetermined cooling water temperature, determining whether a value of a road grade transmitted from the ECU is smaller than a set value for a predetermined road grade, determining whether a value of motor torque transmitted from an MCU is larger than “0”, determining whether a value of an acceleration pedal transmitted from the ECU is smaller than a set value for a predetermined acceleration pedal, determining whether an absolute value of a variation rate of the acceleration pedal transmitted from the ECU is smaller than a set value for a predetermined variation rate of the acceleration pedal, calculating a target vehicle speed based on collected information collected from the ECU, the TCU, and the MCU when one or two or more determination steps among the determining of the cooling water temperature, the determining of the road grade, the determining of the motor torque, the determining of the acceleration pedal, and the determining of the variation rate of the acceleration pedal are satisfied, calculating a variation value of a vehicle speed by comparing an actual vehicle speed of a vehicle with the calculated target vehicle speed, calculating a torque deviation value by using the variation value of the vehicle speed when the variation value of the vehicle speed is larger than a predetermined set value, and correcting a target torque amount of an engine by calculating a torque correction value with a torque deviation value and outputting the corrected target torque amount to the ECU.

According to exemplary embodiments of the present invention, a torque correction value calculated by using deviations of torques of an engine and a motor/an alternator is reflected at the time of setting an engine target torque amount, thereby improving drivability of a vehicle and improving control precision.

The methods and apparatuses of the present invention have other features and advantages which will be apparent from or are set forth in more detail in the accompanying drawings, which are incorporated herein, and the following Detailed Description which together serve to explain certain principles of the present invention.

### BRIEF DESCRIPTION OF THE DRAWINGS

FIG. 1 is a block diagram of a vehicle travel torque control system according to an exemplary embodiment of the present invention.

FIG. 2 is a graph for describing motor torque compensating calculation according to an exemplary embodiment of the present invention.

FIG. 3 is a diagram showing a control procedure of a vehicle travel torque control system according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, a vehicle travel torque control system according to an exemplary embodiment of the present invention will be described with reference to the accompanying drawings.

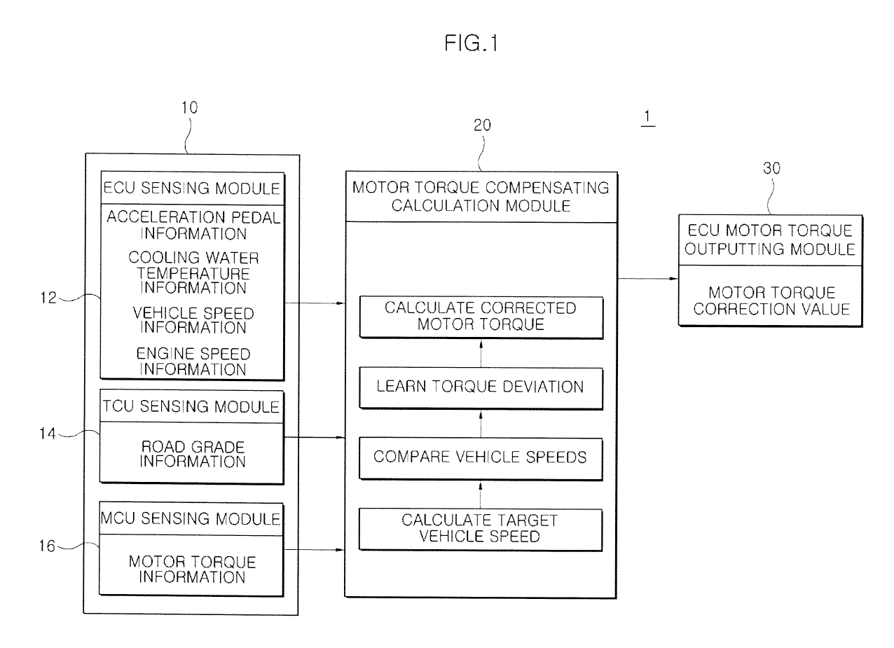

Referring to FIG. 1, vehicle travel torque control system 1 according to the exemplary embodiment may include a sensing module 10, a motor torque compensating calculation module 20, and an engine control unit (ECU) motor torque outputting module 30. Sensing module 10 may be classified into an engine control unit (ECU) sensing module 12, a transmission control unit (TCU) sensing module 14, and a motor control unit (MCU) sensing module 16.

Vehicle travel torque control system 1 according to the exemplary embodiment calculates a deviation of travel torque by comparing an actual vehicle speed of a vehicle with a vehicle speed calculated based on torque information of an engine and a motor/an alternator and reflects the calculated deviation at the time of setting an engine target torque amount, thereby improving drivability of the vehicle and improving control precision.

Sensing module 10 collects various pieces of information associated with travelling in link with the engine control unit (ECU), the transmission control unit (TCU), and the motor control unit (MCU), and transmits the collected information to motor torque compensating calculation module 20.

ECU sensing module 12 in sensing module 10 collects and processes acceleration pedal information, cooling water temperature information, vehicle speed information, and engine speed information from the ECU and thereafter, transmits the collected and processed information to motor torque compensating calculation module 20. TCU sensing module 14 collects and processes road grade information from the TCU and thereafter, transmits the collected and processed information to motor torque compensating calculation module 20. In addition, MCU sensing module 16 collects and processes the motor torque information from the MCU and thereafter, transmits the collected and processed information to motor torque compensating calculation module 20.

Motor torque compensating calculation module 20 calculates a target vehicle speed based on the torque information of the engine and the motor/the alternator, calculates the deviation of the travel torque by comparing the actual vehicle speed of the vehicle with the calculated target vehicle speed, and reflects the calculated deviation at the time of setting the engine target torque amount, thereby improving drivability of the vehicle and improving control precision.

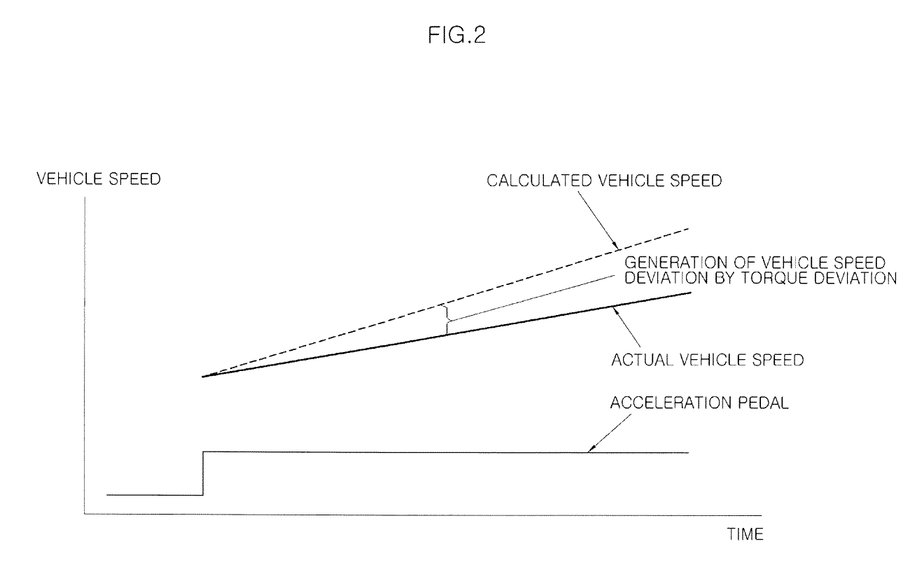

Motor torque compensating calculation module 20 may be divided into four functional blocks of calculating of the target vehicle speed, comparing of the vehicle speeds, learning of the torque deviation, and calculating of corrected motor torque as shown in FIG. 1. Hereinafter, four functional blocks will be described with reference to FIG. 2.

The functional block for the calculating of the target vehicle speed calculates the target vehicle by using torque information of the engine and the motor. When a torque value of the engine is expressed as “P_engine”, a torque value of the motor is expressed as “P_motor”, and the target vehicle speed is expressed as “V_target vehicle speed”, the target vehicle speed may be calculated by an equation of “V_target vehicle speed=(P_engine+P_motor)/F”. Herein, F represents a running resistance value.

The torque value of the motor, P_motor is transmitted from MCU sensing module 16 and the torque value of the engine, P_engine may be calculated by using the engine speed information transmitted from ECU sensing module 12.

The functional block for the comparing of the vehicle speeds performs calculation of subtracting the actual vehicle speed information (V_actual vehicle speed) transmitted from ECU sensing module 12 from the target vehicle speed (V_target vehicle speed) calculated as above to acquire the variation (ΔV) of the vehicle speed. That is, the variation of the vehicle speed may be expressed through an equation such as “ΔV=V_target vehicle speed−V_actual vehicle speed”.

The functional block for the learning of the torque deviation may acquire a torque deviation value by using “ΔV” acquired as above. Specifically, the torque deviation (ΔP_motor) may be calculated by an equation such as “ΔP_motor=F*ΔV.

The functional block for the calculating of the corrected motor torque calculates a torque correction value to correspond to the torque deviation (ΔP_motor) calculated as above. The torque correction value (Torque_correction value) may be calculated by an equation such as “Torque_correction value=ΔP_motor/(2*π*engine speed)”.

ECU motor torque outputting module 30 determines the target torque amount of the engine by reflecting the above-calculated torque correction value onto the existing motor torque value and transmits the determined target torque amount to the ECU.

As described above, vehicle travel torque control system 1 according to the exemplary embodiment of the present invention reflects the torque correction value calculated by using deviations of torques at the time of setting the engine target torque amount, thereby improving drivability of the vehicle and improving control precision.

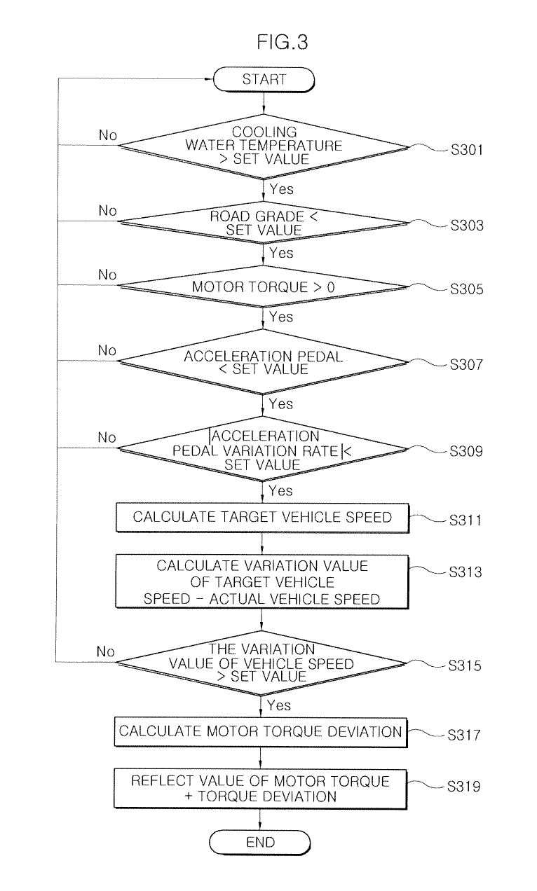

Hereinafter, an operation of vehicle travel torque control system 1 according to the exemplary embodiment of the present invention will be described with reference to FIG. 3. First, vehicle travel torque control system 1 determines whether a value of a cooling water temperature transmitted from an ECU is larger than a set value for a predetermined cooling water temperature (S301) and when the corresponding value is not larger than the set value for the cooling water temperature, the process proceeds to step S301.

As a determination result in step S301, vehicle travel torque control system 1 determines whether a value of a road grade transmitted from the ECU is smaller than a set value for a predetermined road grade when the corresponding value is larger than the set value for the cooling water temperature (S303) and when the transmitted road grade value is not smaller than the set value for the road grade, the process returns to step S301.

As a determination result in step S303, vehicle travel torque control system 1 determines whether a value of motor torque transmitted from an MCU is larger than “0” when the transmitted road grade value is smaller than the set value for the road grade (S305) and when the motor torque value is not larger than “0”, the process returns to step S301.

As a determination result in step S305, vehicle travel torque control system 1 determines whether a value of an acceleration pedal transmitted from the ECU is smaller than a set value for a predetermined acceleration pedal when the motor torque value is larger than “0” (S307) and when the acceleration pedal value is not smaller than the set value for the acceleration pedal, the process returns to step S301.

As a determination result of step S307, vehicle travel torque control system 1 determines whether an absolute value of a variation rate of the acceleration pedal transmitted from the ECU is smaller than a set value for a predetermined variation rate of the acceleration pedal when the acceleration pedal value is smaller than the set value for the acceleration pedal (S309) and when the absolute value is not smaller than the set value for the variation rate of the acceleration pedal, the process returns to step S301.

As a determination result of step S309, vehicle travel torque control system 1 calculates a target vehicle speed value by using a torque value of an engine and a torque value of a motor when the absolute value is smaller than the set value for the variation rate of the acceleration pedal (S311). That is, the target vehicle speed value is calculated by the functional block for the calculating of the target vehicle speed in motor torque compensating calculation module 20 shown in FIG. 1.

Next, vehicle travel torque control system 1 may acquire a variation (ΔV) value of the vehicle speed by subtracting a value of an actual vehicle speed transmitted from the ECU from the target vehicle speed calculated as above (S313).

Next, vehicle travel torque control system 1 determines whether the variation value of the vehicle speed is larger than a set value for the predetermined variation of the vehicle speed (S315) and when the variation value is not larger than the set value for the variation of the vehicle speed, the process returns to step S301.

As a determination result in step S315, vehicle travel torque control system 1 may calculate a deviation (ΔP) of motor torques by using the variation (ΔV) of the vehicle speed when the variation value is larger than the set value for the variation of the vehicle speed (S317). That is, the motor torque deviation (ΔP) may be calculated by the functional block for the learning of the torque deviation in motor torque compensating calculation module 20 shown in FIG. 1.

Vehicle travel torque control system 1 determines the target torque amount of the engine by reflecting the above-calculated torque correction value onto the existing motor torque value and transmits the determined target torque amount to the ECU (S319).

As described above, vehicle travel torque control system 1 according to the exemplary embodiment, as a system that can effectively reflect the motor torque deviation onto control of the engine torque, can be effectively applied to a hybrid vehicle.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A vehicle travel torque control system, comprising:
a sensing module that interworks with an engine control unit (ECU) controlling an engine, a transmission control unit (TCU) controlling a transmission, and a motor control unit (MCU) controlling a motor/an alternator, to collect information associated with each of the units;
a motor torque compensating calculation module that determines a variation value of a vehicle speed by comparing an actual vehicle speed of a vehicle with a target vehicle speed determined based on the information collected by the sensing module to determine a torque deviation value of a travel torque and determines a torque correction value by using the determined torque deviation value of the travel torque; and
an ECU motor torque outputting module that corrects a target torque amount of the engine by using the torque correction value and outputs a corrected target torque amount to the ECU.

2. The vehicle travel torque control system as defined in claim 1, wherein the motor torque compensating calculation module includes:
a target vehicle speed calculating functional block determining the target vehicle speed by using torque values of the engine and the motor in the collected information;
a vehicle speed comparing functional block determining the variation value of the vehicle speed by comparing the actual vehicle speed of the vehicle in the collected information with the determined target vehicle speed;
a torque deviation learning functional block determining the torque deviation value of the travel torque by using the variation value of the vehicle speed; and
a corrected motor torque calculating functional block determining the torque correction value by using the determined torque deviation value.

3. The vehicle travel torque control system as defined in claim 2, wherein in the target vehicle speed calculating functional block,
when the target vehicle speed is expressed as “V_target vehicle speed”, a torque value of the motor transmitted from the MCU in the collected information is expressed as “P_motor”, and a torque value of the engine determined by using an engine speed transmitted from the ECU is expressed as “P_engine”, the target vehicle speed is determined by an equation of “V_target vehicle speed=(P_engine+P_motor)/F” wherein “F” represents a running resistance value.

4. The vehicle travel torque control system as defined in claim 3, wherein in the vehicle speed comparing functional block,
when the variation value of the vehicle speed is expressed as “ΔV” and the actual vehicle speed is expressed as “V_actual vehicle speed”, the variation value of the vehicle speed is determined by an equation of “ΔV=V_target vehicle speed−V_actual vehicle speed”.

5. The vehicle travel torque control system as defined in claim 4, wherein in the torque deviation learning functional block,
when the torque deviation value is expressed as “ΔP_motor”, the torque deviation value is determined by an equation of “ΔP_motor=F*ΔV”.

6. The vehicle travel torque control system as defined in claim 5, wherein in the corrected motor torque calculating functional block,
when the torque correction value is expressed as “Torque_correction value”, the torque correction value is determined by an equation of “Torque_correction value=ΔP_motor/(2*π*engine speed)”.

7. The vehicle travel torque control system as defined in claim 1, wherein the motor torque compensating calculation module is operated when a value of a cooling water temperature transmitted from the ECU is larger than a set value for a predetermined cooling water temperature, a value of a road grade transmitted from the ECU is smaller than a set value for a predetermined road grade, a value of motor torque transmitted from the MCU is larger than “0”, a value of an acceleration pedal transmitted from the ECU is smaller than a set value for a predetermined acceleration pedal, and an absolute value of a variation rate of the acceleration pedal transmitted from the ECU is smaller than a set value for a predetermined variation rate of the acceleration pedal.

8. The vehicle travel torque control system as defined in claim 1, wherein the sensing module, the motor torque compensating calculation module, and the ECU motor torque outputting module are applied to a hybrid vehicle to perform their own functions.

9. A control method of a vehicle travel torque control system that interworks with an engine control unit (ECU), a transmission control unit (TCU), and a motor control unit (MCU) controlling a motor/an alternator, the method comprising:
determining whether a value of a cooling water temperature transmitted from the ECU is larger than a set value for a predetermined cooling water temperature;
determining whether a value of a road grade transmitted from the ECU is smaller than a set value for a predetermined road grade;
determining whether a value of a motor torque transmitted from the MCU is larger than “0”;
determining whether a value of an acceleration pedal transmitted from the ECU is smaller than a set value for a predetermined acceleration pedal;
determining whether an absolute value of a variation rate of the acceleration pedal transmitted from the ECU is smaller than a set value for a predetermined variation rate of the acceleration pedal;
determining a target vehicle speed based on collected information collected from the ECU, the TCU, and the MCU when one or two or more determination steps among the determining of the cooling water temperature, the determining of the road grade, the determining of the motor torque, the determining of the acceleration pedal, and the determining of the variation rate of the acceleration pedal are satisfied;
determining a variation value of a vehicle speed by comparing an actual vehicle speed of a vehicle with the determined target vehicle speed;
determining a torque deviation value by using the variation value of the vehicle speed when the variation value of the vehicle speed is larger than a predetermined set value; and
correcting a target torque amount of an engine by determining a torque correction value with the torque deviation value and outputting a corrected target torque amount to the ECU.
